(19) United States
(12) Patent Application Publication
(10) Pub. No.: US 2019/0023232 A1
(43) Pub. Date: Jan. 24, 2019

(54) WASHER TANK

(71) Applicant: HONDA MOTOR CO., LTD., Tokyo (JP)

(72) Inventors: Koji OKABE, Wako-shi (JP); Takeshi SASAKI, Wako-shi (JP); Takuro HASHIMOTO, Wako-shi (JP); Motoki MINAMI, Wako-shi (JP)

(21) Appl. No.: 16/033,888

(22) Filed: Jul. 12, 2018

(30) Foreign Application Priority Data
Jul. 20, 2017 (JP) 2017-141299

(51) Int. Cl. B60S 1/50

(52) U.S. Cl. CPC B60S 1/50; B60S 1/487

(57) ABSTRACT

A washer tank is mounted on a vehicle and stores washer fluid. A first tilted portion tilted upward toward an inner side of the washer tank is formed on an inner surface of a side wall portion of the washer tank.

### BACKGROUND OF THE INVENTION

### 1. Field of the Invention

The present invention relates to a washer tank in a system which supplies washer fluid to a target in a vehicle.

### 2. Description of the Related Art

Patent literature 1 discloses that a cleaning fluid from a cleaning fluid tank is mixed with compressed air from a compressor in piping, and the cleaning fluid bubbled in an emulsion state is sprayed to a floor surface of a vehicle.
Patent Literature 1: JP 58-028938 Y

### SUMMARY OF THE INVENTION

However, the technique described in JP 58-028938 Y has a problem that the compressor is necessary to cause air bubbles to be contained in the cleaning fluid, and an apparatus for this technique is too large and complex to be mounted on a vehicle.

The present invention has been made in view of the above point, and an object of the present invention is to provide a washer tank which improves a capability of cleaning a target in a vehicle with a simple configuration.

In order to solve the above problem, a washer tank including a first tilted portion which is formed on an inner surface of a side wall portion of the washer tank and is tilted upward toward an inner side of the washer tank, wherein the washer tank is mounted on a vehicle and stores washer fluid, is provided.

According to the present invention, a capability of cleaning a target in a vehicle can be improved with a simple configuration.

### BRIEF DESCRIPTION OF THE DRAWINGS

FIG. 1 is a perspective view of a vehicle to which a washer fluid supply system according to a first embodiment of the present invention is applied;

FIG. 2 is a schematic view of the washer fluid supply system according to the first embodiment of the present invention;

FIG. 3 is a cross-sectional view of a washer tank according to the first embodiment of the present invention;

FIG. 4 is a partially-enlarged view of FIG. 3;

FIG. 5 is a cross-sectional view of a heat retention tank according to the first embodiment of the present invention;

FIG. 6 is an exterior view schematically showing a connecting portion according to the first embodiment of the present invention;

FIG. 7 is an exterior view of the connecting portion in FIG. 6 as viewed in the direction VII;

FIG. 8 is a cross-sectional view along the line VIII-VIII in FIG. 6;

FIG. 9 is a cross-sectional view along the line IX-IX in FIG. 7;

FIG. 10 is a graph showing a saturated vapor pressure curve of water;

FIG. 11 is a perspective view showing a wiper arm, a wiper blade, and a supply portion;

FIGS. 12A to 12C are graphs showing examples of changes in pump output and a supply amount of washer fluid to a window panel over time;

FIG. 13 is a graph showing an example of relationships between a target temperature and alcohol concentration of the washer fluid in the heat retention tank;

FIG. 14 is a schematic view showing a washer fluid supply system according to a second embodiment of the present invention;

FIG. 15 is a cross-sectional view showing a supply portion according to the second embodiment of the present invention;

FIG. 16 is a cross-sectional view showing a supply portion according to a third embodiment of the present invention;

FIG. 17 is a cross-sectional view showing a heat retention tank according to a fourth embodiment of the present invention;

FIG. 18 is a schematic view showing a washer fluid supply system according to a fifth embodiment of the present invention; and

FIG. 19 is a schematic view showing a washer fluid supply system according to a sixth embodiment of the present invention.

### DETAILED DESCRIPTION OF THE EMBODIMENTS

Embodiments of the present invention are described in detail with reference to the drawings. As an example, the case where a washer fluid supply system of the present invention supplies washer fluid to a target window panel will be used. In the following description, the same elements will be denoted by the same reference numerals, and the same description will be omitted.

### First Embodiment

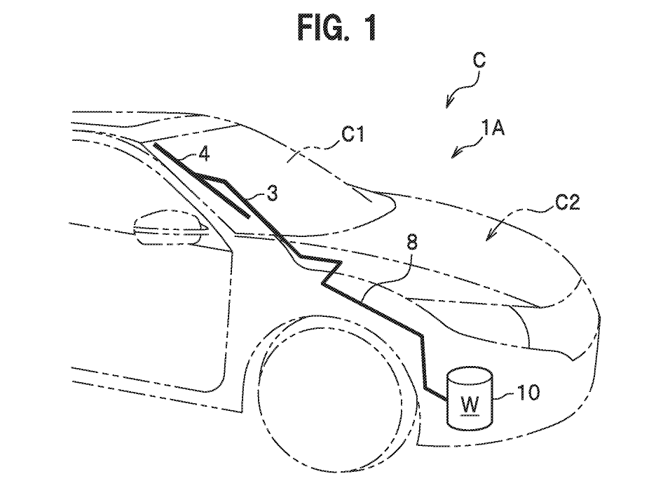

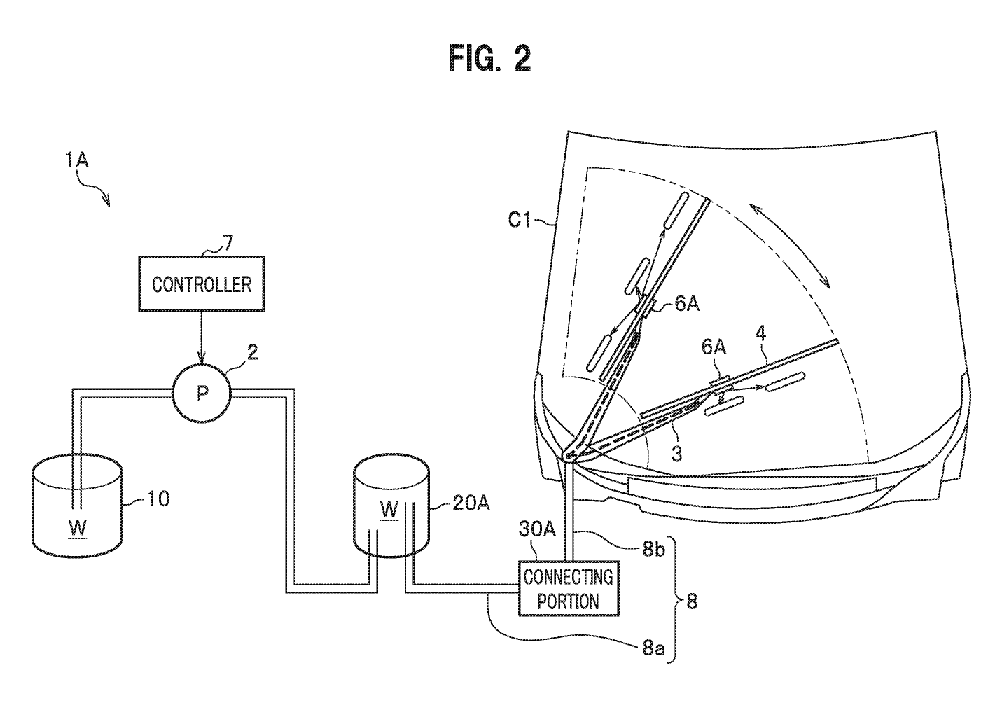

As shown in FIGS. 1 and 2, a washer fluid supply system 1A according to a first embodiment of the present invention is a system which supplies washer fluid W to a window panel C1 serving as a windshield of a vehicle C. The washer fluid W contains water, alcohol, and the like, and serves as an anti-freeze solution. The washer fluid supply system 1A includes a washer tank 10, a pump (delivery portion) 2, a heat retention tank (heating portion) 20A, a connecting portion 30A, a wiper arm 3, a wiper blade 4, a supply portion 6A, and a controller 7. The washer tank 10, the heat retention tank 20A, the connecting portion 30A, and the supply portion 6A are connected in series by a passage portion 8 through which the washer fluid W can flow. The passage portion 8 is formed by flexible tubes or the like.

### <Washer Tank>

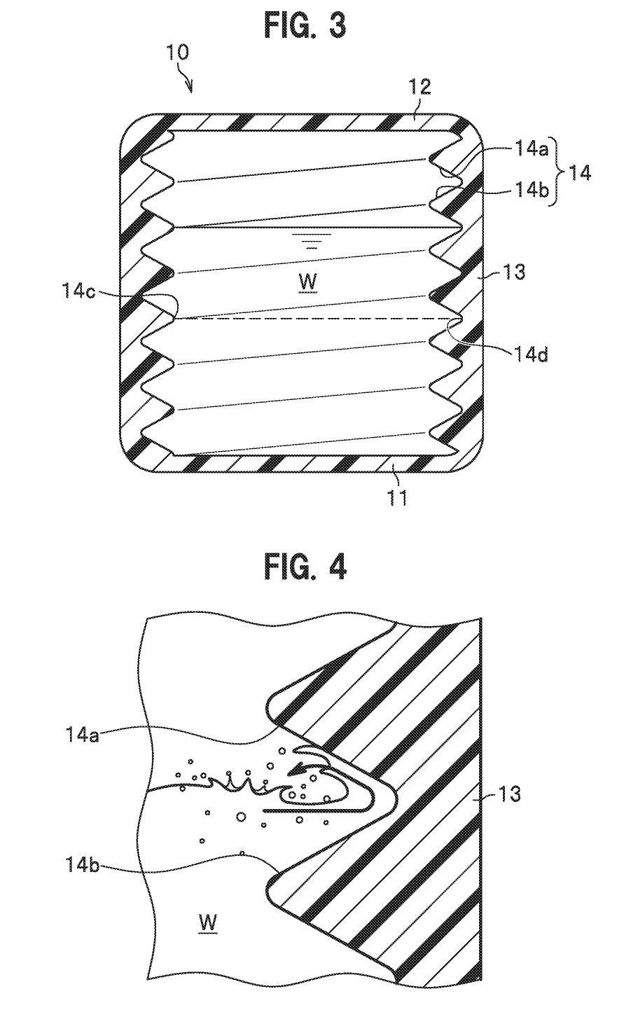

As shown in FIG. 3, the washer tank 10 is provided in a power source compartment C2 formed in a front portion of the vehicle C, and stores the washer fluid W. The washer fluid W stored in the washer tank 10 flows out of the washer tank 10 through the passage portion 8 (see FIG. 1) and is delivered to the supply portion 6A. The washer tank 10 is made of a resin member having a bottomed cylindrical shape, and integrally includes a bottom wall portion 11 and an upper wall portion 12 which have circular shapes in a plane view, and aside wall portion 13 which extends in vertical direction to connect peripheral edge portions of the bottom wall portion 11 and the upper wall portion 12 and which has an annular shape in the plan view. A groove portion 14 is formed on an inner peripheral surface of the side wall portion 13.

### <<Groove Portion, First Tilted Portion, and Second Tilted Portion>>

The groove portion 14 has a helical shape about an axis of the washer tank 10, and includes a first tilted portion 14a and a second tilted portion 14b. The first tilted portion 14a is a surface tilted to extend upward toward the inner side in a radial direction of the washer tank 10. The second tilted portion 14b is a surface tilted to extend downward toward the inner side in the radial direction of the washer tank 10. The second tilted portion 14b is continuously provided to the first tilted portion 14a. The first tilted portion 14a and the second tilted portion 14b alternately appear in a height direction. That is, the first tilted portion 14a on the lower side and the second tilted portion 14b on the upper side are continuous, and form a protruding portion which protrudes toward the inner side in the radial direction of the washer tank 10. Moreover, the first tilted portion 14a on the upper side and the second tilted portion 14b on the lower side are continuous, and form a recess portion which is recessed toward an outer side in the radial direction of the washer tank 10. The protruding portion and the recess portion have a triangular shape in a cross-sectional view respectively. Moreover, a vertex 14d of the recess portion of the groove portion 14 is provided in a portion opposite to a vertex 14c of the protruding portion of the groove portion 14, at the same height in the side wall portion 13 of the washer tank 10.

### <Generation of Air Bubbles in Washer Tank>

The fluid surface of the washer fluid W stored in the washer tank 10 described above moves up and down due to vibration caused by traveling of the vehicle C and the like. As shown in FIG. 4, the washer fluid W near the fluid surface rises along the second tilted portion 14b, splashes on the first tilted portion 14a, turns into droplets, and falls to the fluid surface of the washer fluid W to generate air bubbles in the washer fluid W.

### <Pump>

As shown in FIGS. 1 and 2, the pump 2 generates flow for delivering the washer fluid W stored in the washer tank 10 to the supply portion 6A via the heat retention tank 20A. In the embodiment, the pump 2 is provided between the washer tank 10 and the heat retention tank 20A, in the passage portion 8.

### <Heating Tank>

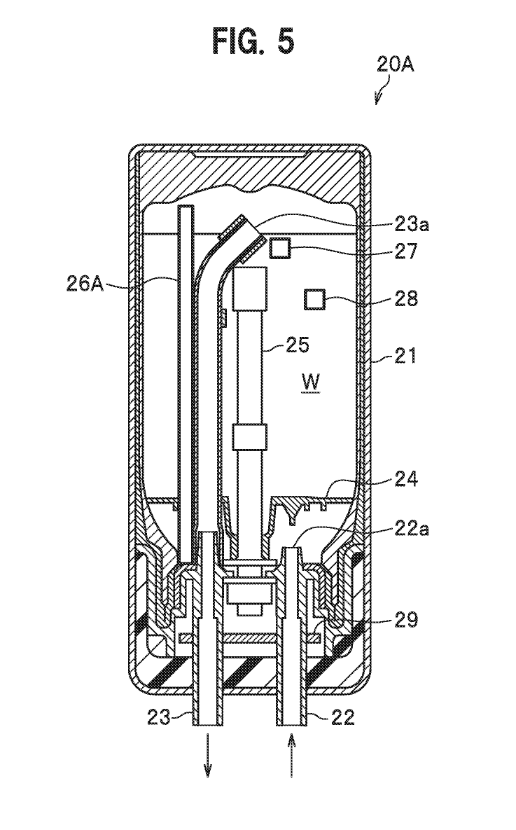

The heat retention tank 20A is provided between the washer tank 10 and the supply portion 6A, and temporarily stores the washer fluid W sent from the washer tank 10 to the supply portion 6A. The heat retention tank 20A has a heating function of heating the washer fluid W temporarily stored in the heat retention tank 20A and a heat retention function of maintaining the temperature of the heated washer fluid W. The heating function and the heat retention function of the heat retention tank 20A described above improve the cleaning performance of the washer fluid W temporarily stored in the heat retention tank 20A and cause the washer fluid W to have a defrosting function. That is, the heat retention tank 20A is also a heater which heats the washer fluid W. As shown in FIG. 5, the heat retention tank 20A includes a tank main body 21, an inflow-side passage portion 22, a discharge-side passage portion 23, a deflector 24, a heater 25, a fluid amount detector 26A, an alcohol concentration detector 27, a fluid temperature detector 28, and a control circuit board (controller) 29.

### <<Tank Main Body>>

The tank main body 21 is a resin or metal tank in which the washer fluid W is temporarily stored. The tank main body 21 has the heat retention function of maintaining the temperature of the washer fluid W therein by adopting a structure such as a double-layer structure in which a foam material or air is present between layers.

### <<Inflow-Side Passage Portion, Discharge-Side Passage Portion>>

The inflow-side passage portion 22 supplies the washer fluid W sent from the washer tank 10 into the tank main body 21. The discharge-side passage portion 23 discharges the washer fluid W in the tank main body 21 toward the supply portion 6A. The passage portions 22, 23 are formed of tubes or the like and are inserted into the tank main body 21 from a bottom wall portion of the tank main body 21.

An opening 23a of the discharge-side passage portion 23 is provided above an opening 22a of the inflow-side passage portion 22. That is, when the fluid surface of the washer fluid W delivered into the tank main body 21 by the pump 2 is above the opening 23a of the discharge-side passage portion 23, the washer fluid W in the tank main body 21 is delivered from the discharge-side passage portion 23 toward the supply portion 6A. Moreover, in the tank main body 21, a space is formed above the opening 23a of the discharge-side passage portion 23 in consideration of expansion of the washer fluid W.

### <<Deflector>>

The deflector 24 is provided above the opening 22a of the inflow-side passage portion 22 and below the opening 23a of the discharge-side passage portion 23 in the tank main body 21 and is provided at a position facing the opening 22a of the inflow-side passage portion 22.

### <<Heater>>

The heater 25 is a heater main body which is provided in the tank main body 21 and which heats the washer fluid W temporarily stored in the tank main body 21.

### <<Fluid Amount Detector>>

The fluid amount detector 26A is provided in the tank main body 21 and detects the fluid amount of the washer fluid W temporarily stored in the tank main body 21. In the embodiment, the fluid amount detector 26A is a level sensor which detects the fluid surface of the washer fluid W temporarily stored in the tank main body 21. The fluid amount detector 26A outputs a detection result to the controller 7 (see FIG. 2).

### <<Alcohol Concentration Detector>>

The alcohol concentration detector 27 is provided in the tank main body 21 and detects the alcohol concentration of the washer fluid W temporarily stored in the tank main body 21. The alcohol concentration detector 27 outputs a detection result to the control circuit board 29. In the embodiment, the alcohol concentration detector 27 detects the alcohol concentration of the washer fluid W at a position closer to the opening 23a of the discharge-side passage portion 23 than to the opening 22a of the inflow-side passage portion 22.

### <<Fluid Temperature Detector>>

The fluid temperature detector 28 is provided in the tank main body 21 and detects the temperature (fluid temperature) of the washer fluid W temporarily stored in the tank main body 21. The fluid temperature detector 28 outputs a detection result to the control circuit board 29.

### <<Control Circuit Board>>

The control circuit board 29 controls the heater 25 based on the detection result of the alcohol concentration detector 27 such that the fluid temperature detected by the fluid temperature detector 28 becomes close to a preset target temperature. A method of controlling the heater 25 by the control circuit board 29 is described later.

### <Connecting Portion>

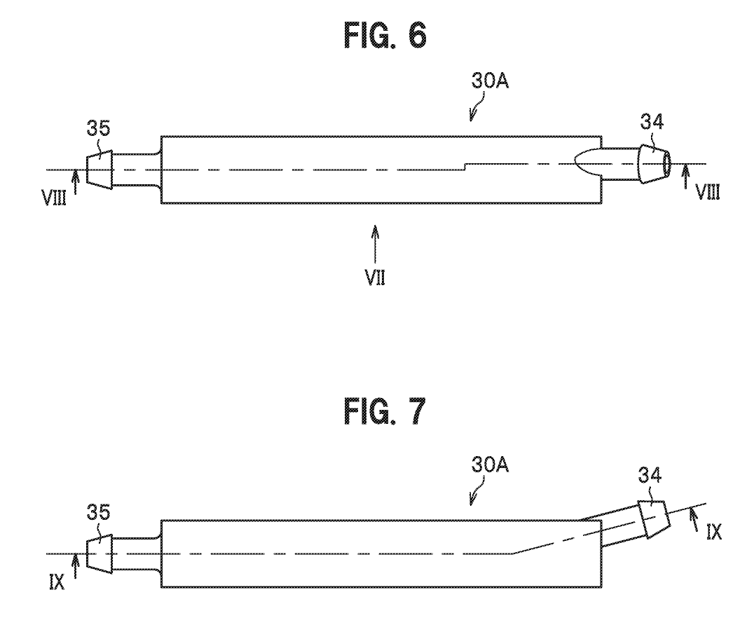

As shown in FIGS. 1 and 2, the connecting portion 30A is provided between the washer tank 10 and the supply portion 6A, in detail between the heat retention tank 20A and the supply portion 6A. The connecting portion 30A is an air bubble portion which causes air bubbles to be contained in the washer fluid W flowing through the connecting portion 30A. As shown in FIGS. 6 to 9, the connecting portion 30A is a metal member with a cylindrical shape. An inflow passage portion 31, a connection passage portion 32, and a discharge passage portion 33 are formed in this order from the upstream side in the connecting portion 30A. A flexible first tube 8a is connected to an upstream end portion of the connecting portion 30A and a flexible second tube 8b is connected to a downstream end portion of the connecting portion 30A. Here, the first tube 8a forms at least part of a first passage portion connecting the washer tank 10 (heat retention tank 20A in the embodiment) and the connecting portion 30A. The second tube 8b forms at least part of a second passage portion connecting the supply portion 6A and the connecting portion 30A.

The inflow passage portion 31 is a passage through which the washer fluid W from the upstream side flows. An upstream end of the inflow passage portion 31 is an inflow portion 31a connected to the first tube (first passage portion) 8a.

The connection passage portion 32 is a passage through which the washer fluid W from the inflow passage portion 31 flows. The connection passage portion 32 includes a large-diameter portion 32a, a diameter-decreasing portion 32b whose diameter decreases toward the downstream side such that the passage cross section area decreases, a restriction portion 32c, a diameter-increasing portion 32d whose diameter increases toward the downstream side such that the passage cross section area increases, a small-diameter portion 32e whose passage cross section area is smaller than that of the large-diameter portion 32a, and a diameter-decreasing portion 32f whose diameter decreases toward the downstream side such that the passage cross section area decreases. The passage cross section area of an upstream portion of the diameter-decreasing portion 32b is the same as the passage cross section area of the large-diameter portion 32a. The passage cross section area of a downstream end portion of the diameter-decreasing portion 32b and the passage cross section area of an upstream end portion of the diameter-increasing portion 32d are the same as the passage cross section area of the restriction portion 32c. The passage cross section area of a downstream end portion of the diameter-increasing portion 32d and the passage cross section area of an upstream end portion of the diameter-decreasing portion 32f are the same as the passage cross section area of the small-diameter portion 32e. The passage cross section area of a downstream end portion of the diameter-decreasing portion 32f is the same as the passage cross section area of the discharge passage portion 33. Moreover, the passage length of the diameter-decreasing portion 32b is smaller than the passage length of the diameter-increasing portion 32d.

The discharge passage portion 33 is a passage through which the washer fluid W from the connection passage portion 32 flows. A downstream end of the discharge passage portion 33 is a discharge portion 33a to which a second tube (second passage portion) 8b is connected. The passage cross section area of the discharge passage portion 33 is the same as the passage cross section area of the inflow passage portion 31 and is smaller than the passage cross section area of the large-diameter portion 32a and the passage cross section area of the small-diameter portion 32e.

A portion of the connecting portion 30A in which the inflow passage portion 31 is formed is a first fitting portion 34 to (on) which the first tube 8a is fitted. That is, the inflow portion 31a is formed in the first fitting portion 34. Moreover, a portion of the connecting portion 30A in which the discharge passage portion 33 is formed is a second fitting portion 35 to (on) which the second tube 8b is fitted. That is, the discharge portion 33a is formed in the second fitting portion 35.

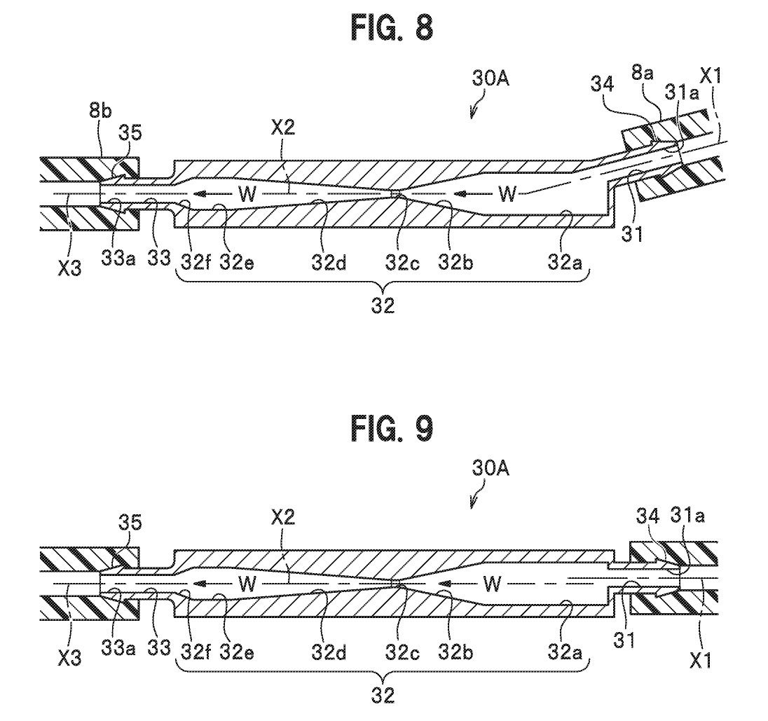

The inflow passage portion 31 which is the passage portion in the first fitting portion 34 extends in a direction intersecting the connection passage portion 32. Moreover, the connection passage portion 32 and the discharge passage portion 33 which is the passage portion in the second fitting portion 35 extend on the same straight line. That is, as shown in FIG. 8, for example, in the plan view, the passage center X1 of the inflow passage portion 31 intersects the passage center X2 of the connection passage portion 32. Moreover, the passage center X3 of the discharge passage portion 33 and the passage center X2 of the connection passage portion 32 are provided on the same straight line. Furthermore, as shown in FIG. 9, for example, in a side view, the passage center X1 of the inflow passage portion 31 is offset from and parallel to the passage center X2 of the connection passage portion 32.

### <Air Bubble Generation in Connecting Portion>

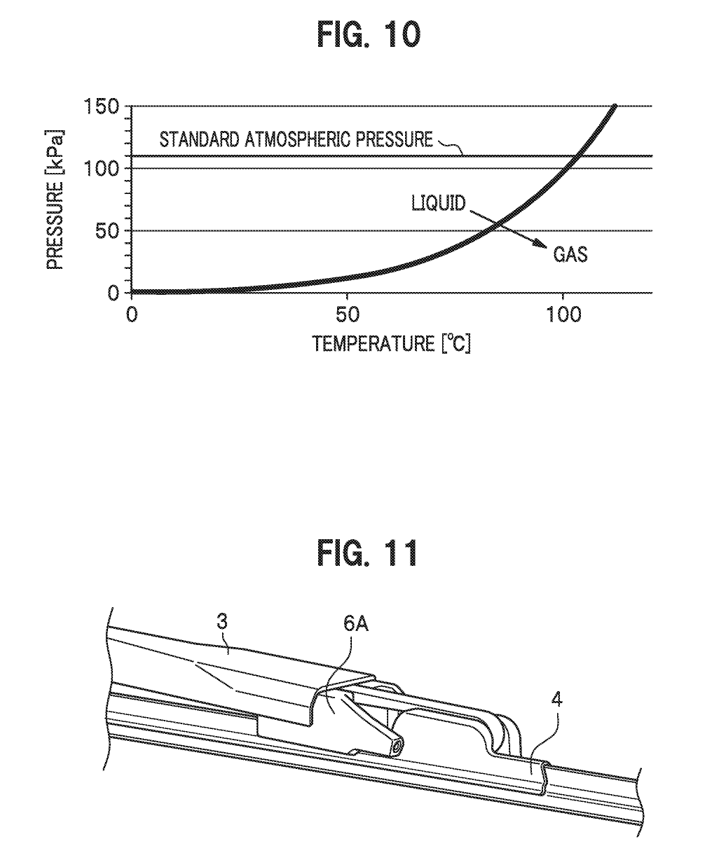

As shown in FIG. 10, when the state of water changes from the liquid side to the gas side of the saturated vapor pressure curve, cavitation occurs in water. Moreover, the higher the fluid temperature of the washer fluid W is, the higher the pressure at which the washer fluid W turns to gas is, and the cavitation is more likely to occur. As shown in FIGS. 6 to 9, in the connecting portion 30A, the restriction portion 32c reduces the fluid pressure of the washer fluid W by increasing the flow speed of the washer fluid W. Air dissolved in the fluid is thereby extracted and air bubbles are generated in the washer fluid W. Moreover, the diameter-increasing portion 32d increases the fluid pressure of the washer fluid W by reducing the flow speed of the washer fluid W. The air bubbles are thereby agitated in the washer fluid W as micro bubbles.

Moreover, the washer fluid W forms a swirling flow when flowing from the inflow passage portion 31 to the connection passage portion 32, and air bubbles are thereby efficiently generated.

### <Wiper Arm and Wiper Blade>

As shown in FIGS. 1 and 2, a base end portion of the wiper arm 3 is swingably supported on a lower end portion of the window panel C1. The wiper blade 4 is used to wipe the window panel C1. A middle portion of the wiper blade 4 in a width direction thereof is turnably supported on a distal end of the wiper arm 3.

### <Supply Portion>

The supply portion 6A is a part in a target side end portion of the washer fluid supply system 1A which discharges and supplies the washer fluid W from the washer tank 10 to the window panel C1. The supply portion 6A is provided integrally with the wiper arm 3 or the wiper blade 4. As shown in FIG. 11, the supply portion 6A according to the present embodiment is provided integrally with a distal end portion of the wiper arm 3 and functions as a nozzle which sprays the washer fluid W to a wiping range of the wiper arm 3.

### <Controller>

The controller 7 is formed of a central processing unit (CPU), a read-only memory (ROM), a random access memory (RAM), an input-output circuit, and the like. The controller 7 controls the pump 2 based on the detection results of the fluid amount detector 26A and the alcohol concentration detector 27.

### <Initial Discharge Amount Increasing Control>

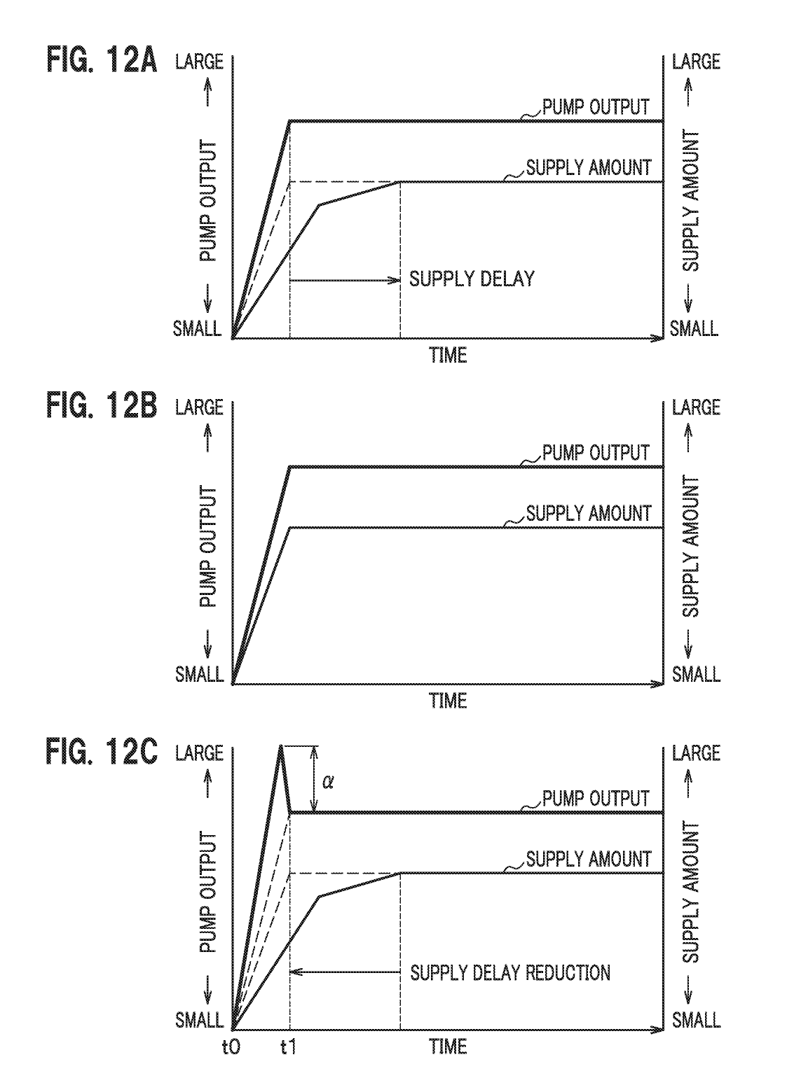

When a driver of the vehicle C operates an operation portion (not shown), the controller 7 drives the pump 2 to supply the washer fluid W to the window panel C1. In this case, for example, when the washer fluid W is not supplied for along time, the fluid surface of the washer fluid W falls below the opening 23a of the discharge-side passage portion 23 due to evaporation of a water content and volatilization of an alcohol content in the washer fluid W in the tank main body 21 of the heat retention tank 20A. When the washer fluid W is supplied to the window panel C1 in such a situation, the time taken for the fluid surface of the washer fluid W to reach the opening 23a of the discharge-side passage portion 23 corresponds to supply delay of the washer fluid W to the window panel C1 (see FIG. 12A).

Accordingly, the controller 7 reduces the supply delay by increasing the output of the pump 2 in an initial stage of the supplying of the washer fluid W.

In the embodiment, the controller 7 sets an increase amount by which the delivery amount (delivery amount of the washer fluid W per unit time) is temporarily increased, based on the detection amount of the fluid amount detector 26A.

Here, when the detection result of the fluid amount detector 26A indicates that the fluid level of the washer fluid W is at or above the opening 23a of the discharge-side passage portion 23, the controller 7 sets the increase amount of the delivery amount (that is, an increase amount a of the output of the pump 2) to zero (see FIG. 12B).

Meanwhile, when the detection result of the fluid amount detector 26A indicates that the fluid level of the washer fluid W is below the opening 23a of the discharge-side passage portion 23, the controller 7 sets an increase amount (see FIG. 12C).

In this case, the controller 7 can set the increase amount such that the lower the fluid level of the washer fluid W relative to the opening 23a is, the larger the increase amount is.

As described above, when the detection result of the fluid amount detector 26A indicates that the fluid level of the washer fluid W is below the opening 23a of the discharge-side passage portion 23, in a period from a time point t₀ (time of starting control of the pump 2) to a predetermined time point t₁ which is the initial stage of the supplying of the washer fluid W to the window panel C1, the controller 7 increases the output of the pump 2 by a compared to the output after the time point t₁. Moreover, after the time point t₁, the controller 7 drives the pump 2 at predetermined output. The predetermined period from the time point t₀ to the time point t₁ can be set based on the time taken for the supply amount of the washer fluid W to reach a predetermined value from the supply start in the case where there is no supply delay as shown in FIG. 12B.

Note that the controller 7 can set the increase amount a and the increase period t₀ to t₁ such that the lower the fluid level of the washer fluid W relative to the opening 23a is, the larger the increase amount is and the longer the increase period t₀ to t₁ is.

### <Heating Control Depending on Alcohol Concentration>

When the heater 25 heats the washer fluid W stored in the tank main body 21 of the heat retention tank 20A, the volatilization of alcohol contained in the washer fluid W progresses and the alcohol concentration of the washer fluid W becomes low. When the heating by the heater is stopped with the alcohol concentration of the washer fluid W being low as described above, the washer fluid W may freeze depending on the outside air temperature.

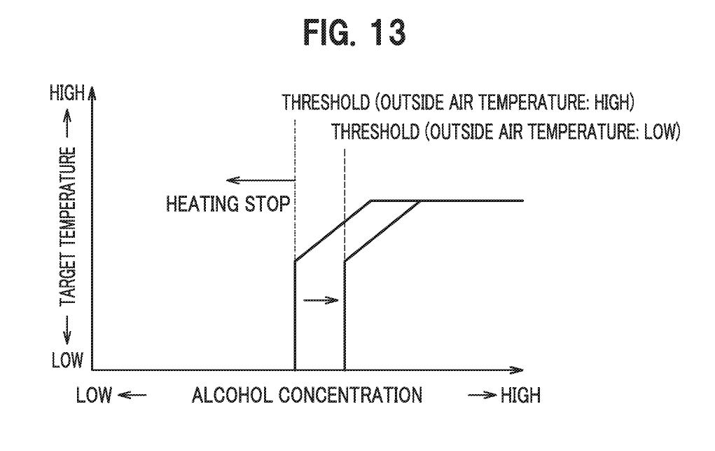

Accordingly, the control circuit board 29 controls the heater 25 based on the detection result of the alcohol concentration detector 27. In detail, when the alcohol concentration detected by the alcohol concentration detector 27 is equal to or lower than a preset threshold, the control circuit board 29 stops the heating by the heater 25 (see FIG. 13). That is, when the alcohol concentration detected by the alcohol concentration detector 27 reaches or falls below the preset threshold during the heating by the heater 25, the control circuit board 29 aborts the heating of the washer fluid W by the heater 25. Moreover, when a condition to start the heating by the heater 25 is established while the heater 25 is stopped, the control circuit board 29 does not heat the washer fluid W with the heater 25.

Moreover, the control circuit board 29 sets a target temperature (heating target temperature) of the washer fluid W to be achieved by the heater 25, based on the detection result of the alcohol concentration detector 27. In detail, when the alcohol concentration is equal to or higher than the threshold, the control circuit board 29 sets the target temperature of the washer fluid W such that the higher the alcohol concentration is, the higher the target temperature is (see FIG. 13).

Since the washer tank 10 according to the first embodiment of the present invention includes the first tilted portion 14a, it is possible to cause air bubbles to be contained in the washer fluid W by using the vibration of the vehicle C, without providing a special mechanism such as a compressor.

Moreover, since the washer tank 10 includes the second tilted portion 14b, it is possible to raise the fluid surface of the washer fluid W to the first tilted portion 14a by using the vibration of the vehicle C and cause air bubbles to be preferably contained in the washer fluid W.

Furthermore, since the washer tank 10 includes a plurality of the first tilted portions 14a provided in vertical direction, even when the fluid amount of the stored washer fluid W changes, the first tilted portion 14a at a position corresponding to the fluid surface of the washer fluid W can cause air bubbles to be contained in the washer fluid W.

Moreover, since a helical groove portion 14 including the first tilted portion 14a and the second tilted portion 14b is formed in the washer tank 10, the washer tank 10 can be easily manufactured.

Furthermore, since the helical groove portion including the first tilted portion 14a is formed in the washer tank 10, even when the fluid amount of the washer fluid W changes, the first tilted portion 14a and the second tilted portion 14b are present at the position corresponding to the fluid surface of the washer fluid W and can cause air bubbles to be preferably contained in the washer fluid W by using the vibration of the vehicle C.

Moreover, in the washer tank 10, since the vertex 14c of the protruding portion of the groove portion 14 is provided opposite to the vertex 14d of the recess portion of the groove portion 14 at the same height, it is possible make the inner surface shape of the washer tank 10 the same at any height in the groove portion 14 and cause air bubbles to be preferably contained in the washer fluid W by using the vibration of the vehicle C.

In the washer fluid supply system 1A according to the first embodiment of the present invention, since the connecting portion (air bubble portion) 30A causes air bubbles to be contained in the washer fluid W, it is possible to cause air bubbles to be contained in the washer fluid W and improve a performance of cleaning the window panel C1 in a simple configuration in which the air bubble portion is mounted on the vehicle C.

Moreover, in the washer fluid supply system 1A, since the connecting portion 30A is provided in the passage portion 8, it is possible to improve the performance of cleaning the window panel C1 in a simple configuration.

Furthermore, in the washer fluid supply system 1A, since the connecting portion 30A connecting the first tube (first passage portion) 8a and the second tube (second passage portion) 8b is configured to be the air bubble portion, the part connecting the first tube (first passage portion) 8a and the second tube (second passage portion) 8b serves also as the air bubble portion and the number of parts can be thereby reduced.

Moreover, in the washer fluid supply system 1A, providing the restriction portion 32c and the diameter-increasing portion 32d in the connecting portion 30A which is the air bubble portion enables generation and agitation of air bubbles in the washer fluid W in a simple configuration.

Furthermore, in the washer fluid supply system 1A, since the first tube 8a and the second tube 8b are fitted to the connecting portion 30A, the part connecting the first tube 8a and the second tube 8b serves also as the air bubble portion and it is possible to reduce the number of parts and also simplify the structure.

Moreover, in the washer fluid supply system 1A, since the passage center X1 of the inflow passage portion 31 intersects the passage center X2 of the connection passage portion 32, a swirling flow of the washer fluid W is generated in the diameter-decreasing portion 32b upstream of the restriction portion 32c and air bubbles can be efficiently generated.

Furthermore, in the washer fluid supply system 1A, since the passage center X3 of the discharge passage portion 33 and the passage center X2 of the connection passage portion 32 are provided on the same straight line, it is possible to reduce the size of the connecting portion 30A and facilitate molding of the connecting portion 30A. Moreover, in the washer fluid supply system 1A, since the angle of the first fitting portion 34 is different from the angle of the second fitting portion 35, the fitting portions 34, 35 are easily distinguishable and it is possible to prevent an attachment error of the connecting portion 30A to the tubes (passage portions) 8a, 8b (for example, attachment in the opposite direction).

Moreover, in the washer fluid supply system 1A, since the amount of the washer fluid W delivered by the pump 2 is temporarily increased, it is possible to quickly raise the fluid surface of the washer fluid W in the heat retention tank 20A and thereby reduce the supply delay of the washer fluid W to the window panel C1. That is, the washer fluid supply system 1A can quickly supply the washer fluid W to the window panel C1 also in the configuration including the heat retention tank 20A.

Furthermore, since the washer fluid supply system 1A sets the increase amount of the delivery amount based on the detection result of the fluid amount detector 26A, it is possible to preferably set the increase amount and prevent the case where an excessive amount of the washer fluid W is supplied from the supply portion 6A to the window panel C1.

Moreover, in the washer fluid supply system 1A, since the fluid amount detector 26A is the level sensor, it is possible to preferably set the increase amount based on the fluid level of the washer fluid W.

Furthermore, since the washer fluid supply system 1A controls the heater 25 based on the detection result of the alcohol concentration detector 27, it is possible to prevent the case where the alcohol concentration of the washer fluid W excessively drops and the washer fluid W discharged from the heat retention tank 20A freezes.

Moreover, since the washer fluid supply system 1A uses the threshold, it is possible to stop the heater 25 before the alcohol concentration of the washer fluid W reaches the concentration at which the washer fluid W freezes by the outside air and preferably prevent the washer fluid W from freezing.

Furthermore, since the washer fluid supply system 1A sets the heating temperature based on the alcohol concentration, the washer fluid supply system 1A can set a low target temperature, for example, when the alcohol concentration of the washer fluid W drops, to suppress the decrease of the alcohol concentration while executing the heating by the heater 25 almost to a point where the alcohol concentration reaches a concentration at which there is a risk of freezing.

Moreover, since the washer fluid supply system 1A detects the alcohol concentration at the position close to the opening 23a of the discharge-side passage portion 23, it is possible to preferably prevent freezing of the washer fluid W also when the washer fluid W accumulates in a portion between the heat retention tank 20A and the supply portion 6A.

### Second Embodiment

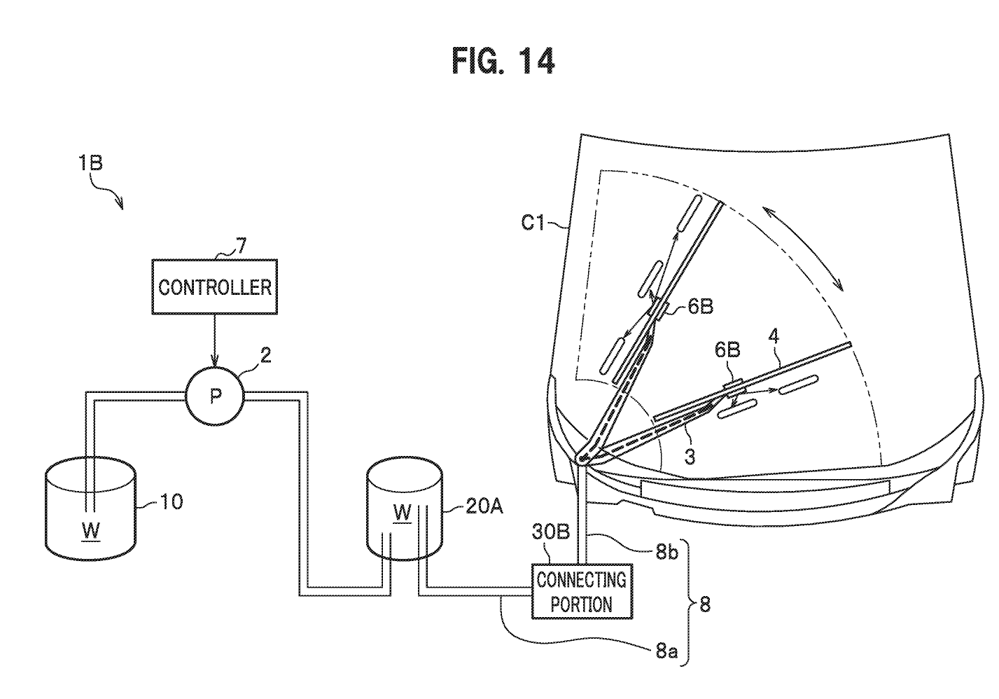

Next, a washer fluid supply system according to a second embodiment of the present invention is described while focusing on differences from the washer fluid supply system 1A according to the first embodiment. As shown in FIG. 14, the washer fluid supply system 1B according to the second embodiment of the present invention includes a connecting portion 30B and a supply portion 6B, instead of the connecting portion 30A and the supply portion 6A. The connecting portion 30B connects the first tube 8a and the second tube 8b and does not have the function of the air bubble portion which causes air bubbles to be contained in the washer fluid W.

### <Supply Portion>

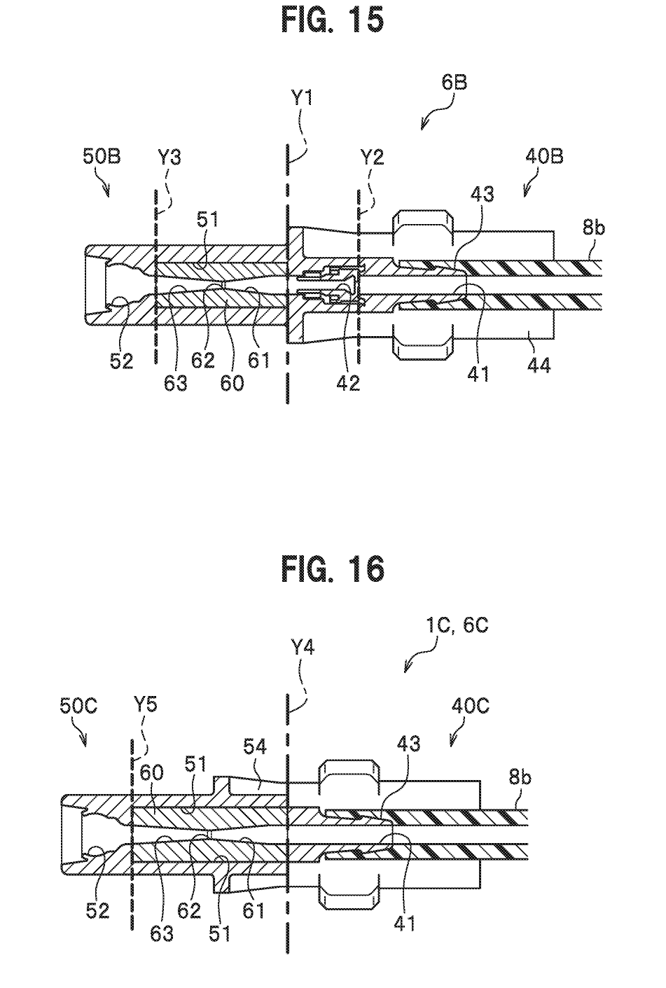

As shown in FIG. 15, the supply portion 6B includes a piping-side member 40B, a nozzle-side member 50B, and an air bubble portion 60.

### <<Piping-Side Member>>

The piping-side member 40B is a metal member forming an upstream portion of the supply portion 6B. In the piping-side member 40B, a passage portion 41 through which the washer fluid W flows is formed. A check valve 42 is provided in the passage portion 41.

The check valve 42 is a one-way valve which prevents back-flow of the washer fluid W. That is, the check valve 42 allows the washer fluid W to flow from the passage portion 8 to the nozzle-side member 50B but prevents the washer fluid W from flowing from the nozzle-side member 50B to the passage portion 8.

An upstream end portion of the piping-side member 40B is a fitting portion 43 to (on) which the second tube 8b of the passage portion 8 being piping is fitted. Moreover, the piping-side member 40B includes an attachment portion 44 for attaching the supply portion 6B to another device (wiper arm 3, wiper blade 4, and the like).

### <<Nozzle-Side Member>>

The nozzle-side member 50B is a cylindrical metal member forming a downstream portion of the supply portion 6B. A housing portion 51 and a nozzle 52 are formed in the nozzle-side member 50B. The air bubble portion 60 is housed in the housing portion 51. The nozzle 52 is formed in a downstream end portion of the nozzle-side member 50B and sprays the washer fluid W flowing through the air bubble portion 60 to the window panel C1.

### <<Air Bubble Portion>>

The air bubble portion 60 is provided integrally with the supply portion 6B and causes air bubbles to be contained in the washer fluid W. In the embodiment, the air bubble portion 60 is incorporated in the nozzle-side member 50B. That is, the air bubble portion 60 is provided on a connection plane Y1 of the piping-side member 40B and the nozzle-side member 50B and, in detail, is provided between the nozzle 52 and the connection plane Y1 of the piping-side member 40B and the nozzle-side member 50B. The air bubble portion 60 includes, as passages through which the washer fluid W flows, a diameter-decreasing portion 61 whose diameter decreases toward the downstream side such that the passage cross section area decreases, a restriction portion 62, and a diameter-increasing portion 63 whose diameter increases toward the downstream side such that the passage cross section area increases, in this order from the upstream side. The passage cross section area of a downstream end portion of the diameter-decreasing portion 61 and the passage cross section area of an upstream end portion of the diameter-increasing portion 63 are the same as the passage cross section area of the restriction portion 62. The relationships of the passage cross section area and the passage length among the diameter-decreasing portion 61, the restriction portion 62, and the diameter-increasing portion 63 may be the same as the relationship of the passage cross section area and the passage length among the diameter-decreasing portion 32b, the restriction portion 32c, and the diameter-increasing portion 32d in the connecting portion 30A. Moreover, the air bubble portion 60 may be configured such that a large-diameter portion similar to the large-diameter portion 32a is provided upstream of the diameter-decreasing portion 61 and a small-diameter portion similar to the small-diameter portion 32e is provided downstream of the diameter-increasing portion 63.

Here, the connection plane Y1 is a plane on which a downstream end portion of the piping-side member 40B is in contact with upstream end portions of the nozzle-side member 50B and the air bubble portion 60. That is, the upstream end portion of the air bubble portion 60 is provided to be flush with the upstream end portion of the nozzle-side member 50B on the connection plane Y1 and is in contact with the downstream end portion of the piping-side member 40B n the connection plane Y1. Moreover, a connection plane Y2 is a plane on which the piping-side member 40B is in contact with an upstream end portion of the check valve 42. Furthermore, a connection plane Y3 is a plane on which the nozzle-side member 50B is in contact with a downstream end portion of the air bubble portion 60.

### <Air Bubble Generation in Nozzle-Side Member>

In the nozzle-side member 50B as described above, the restriction portion 62 reduces the fluid pressure of the washer fluid W by increasing the flow speed of the washer fluid W. Air dissolved in the fluid is thereby extracted and air bubbles are generated in the washer fluid W. Moreover, the diameter-increasing portion 63 increases the fluid pressure of the washer fluid W by reducing the flow speed of the washer fluid W. The air bubbles are thereby agitated in the washer fluid W as micro bubbles.

Since the washer fluid supply system 1B according to the second embodiment of the present invention can cause air bubbles to be contained in the washer fluid W just before the supplying of the washer fluid W, the washer fluid supply system 1B can suppress disappearance of air bubbles during movement of the washer fluid W and preferably exhibit cleaning performance.

Moreover, in the washer fluid supply system 1B, since the air bubble portion 60 is provided on the connection plane Y1 of the piping-side member 40B and the nozzle-side member 50B, it is possible to mold the air bubble portion 60 as a separate part and improve productivity.

Furthermore, in the washer fluid supply system 1B, since the air bubble portion 60 is provided on the connection plane Y1, attachment workability can be improved.

Moreover, in the washer fluid supply system 1B, the air bubble portion 60 is incorporated in the nozzle-side member 50B and the check valve 42 is incorporated in the piping-side member 40B. Accordingly, in the washer fluid supply system 1B, it is possible to attach the air bubble portion 60 and the check valve 42 respectively to separate members and then attach the piping-side member 40B and the nozzle-side member 50B. This can improve the attachment workability.

Moreover, in the washer fluid supply system 1B, since the supply portion 6B is provided in the wiper arm 3 or the wiper blade 4, it is possible to reduce the distance from the portion of air bubble generation to the window panel C1 and suppress disappearance of air bubbles.

Moreover, in the washer fluid supply system 1B, since the heat retention tank 20A is provided upstream of the air bubble portion 60, it is possible to increase the generation amount of air bubbles by causing air bubbles to be contained in the heated washer fluid W and improve the cleaning performance.

### Third Embodiment

Next, a washer fluid supply system according to a third embodiment of the present invention is described while focusing on differences from the washer fluid supply system 1B according to the second embodiment. As shown in FIG. 16, the washer fluid supply system 1C according to the third embodiment of the present invention includes a supply portion 6C, instead of the supply portion 6B.

### <Supply Portion>

The supply portion 6C includes a piping-side member 40C and a nozzle-side member 50C, instead of the piping-side member 40B and the nozzle-side member 50B.

### <<Piping-Side Member>>

The piping-side member 40C does not include the check valve 42 or the attachment portion 44.

### <<Nozzle-Side Member>>

The nozzle-side member 50C includes an attachment portion 54 for attaching the supply portion 6C to another device (wiper arm 3, wiper blade 4, and the like).

Here, a connection plane Y4 is a plane on which a downstream end portion of the piping-side member 40C comes into contact with upstream end portions of the nozzle-side member 50C and the air bubble portion 60. That is, the upstream end portion of the air bubble portion 60 is provided to be flush with the upstream end portion of the nozzle-side member 50C on the connection plane Y4 and is in contact with the downstream end portion of the piping-side member 40C on the connection plane Y4. Moreover, a connection plane Y5 is a plane on which the nozzle-side member 50C is in contact with a downstream end portion of the air bubble portion 60.

The supply portion 6C according to the third embodiment of the present invention has effects similar to those of the supply portion 6B according to the second embodiment, except for the back-flow prevention by the check valve 42.

### Fourth Embodiment

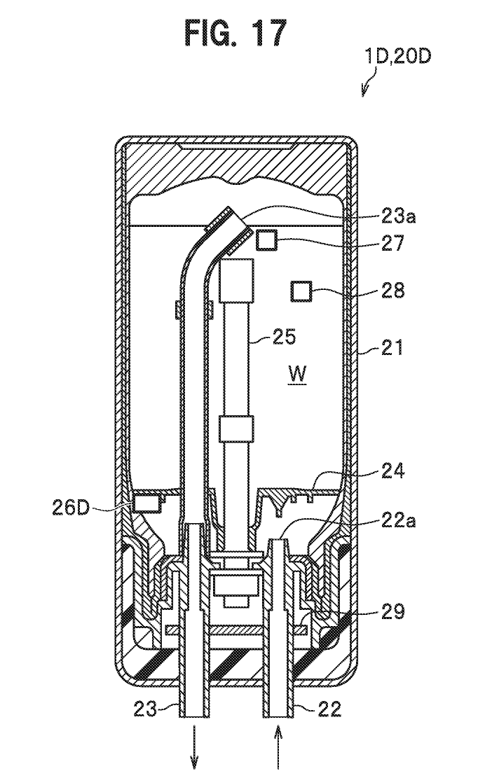

Next, a washer fluid supply system according to a fourth embodiment of the present invention is described while focusing on differences from the washer fluid supply system 1A according to the first embodiment. As shown in FIG. 17, the washer fluid supply system 1D according to the fourth embodiment of the present invention includes a heat retention tank 20D, instead of the heat retention tank 20A.

### <Heat Retention Tank, Fluid Amount Detector>

The heat retention tank 20D includes a fluid amount detector 26D, instead of the fluid amount detector 26A. The fluid amount detector 26D is a weight sensor which detects the weight of the washer fluid W temporarily stored in the tank main body 21. The fluid amount detector 26D outputs the detection result to the controller 7 (see FIG. 2).

The controller 7 stores in advance relationships between the weight of the washer fluid W detected by the fluid amount detector 26D and the fluid level of the washer fluid W as a mathematical formula, a table, or the like. The controller 7 uses such relationships to convert the weight of the washer fluid W detected by the fluid amount detector 26D to the fluid level of the washer fluid W.

In detail, the controller 7 stores in advance the relationships among the weight of the washer fluid W detected by the fluid amount detector 26D, the alcohol concentration detected by the alcohol concentration detector 27, and the fluid level of the washer fluid W, as a mathematical formula, a table, or the like. The controller 7 uses such relationships to convert the weight of the washer fluid W detected by the fluid amount detector 26D to the fluid level of the washer fluid W.

In the washer fluid supply system 1D according to the fourth embodiment of the present invention, since the fluid amount detector 26A is the weight sensor and the controller 7 converts the weight to the fluid level, it is possible to preferably set the increase amount based on the fluid level of the washer fluid W.

Moreover, in the washer fluid supply system 1D, since the deflector 24 hinders the flow of the washer fluid W, the washer fluid W from the inflow-side passage portion 22 can be prevented from flowing to the discharge-side passage portion 23 without being heated.

Furthermore, the washer fluid supply system 1D can detect the weight of the washer fluid W in a simple configuration by using the deflector 24.

Moreover, the washer fluid supply system 1D can preferably obtain the fluid level of the washer fluid W by using the detection result of the alcohol concentration detector 27. Furthermore, in the washer fluid supply system 1D, since the alcohol concentration detector 27 is provided at a position closer to the opening 23a of the discharge-side passage portion 23 than to the opening 22a of the inflow-side passage portion 22, the washer fluid supply system 1D can preferably detect the alcohol concentration.

### Fifth Embodiment

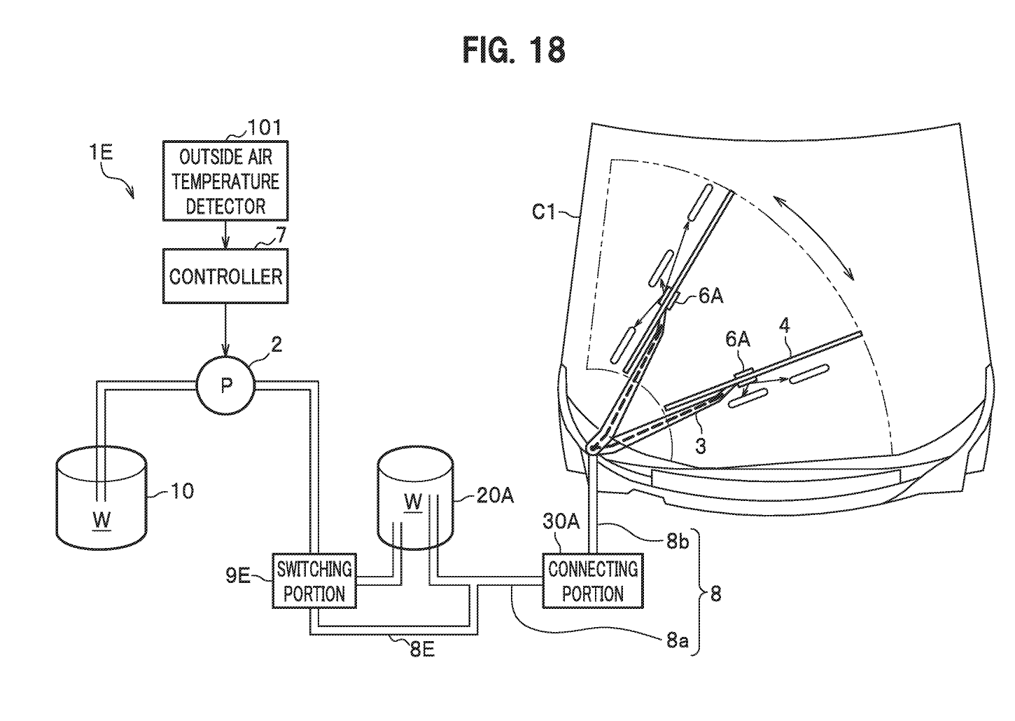

Next, a washer fluid supply system according to a fifth embodiment of the present invention is described while focusing on differences from the washer fluid supply system 1A according to the first embodiment. As shown in FIG. 18, the washer fluid supply system 1E according to the fifth embodiment of the present invention includes a bypass passage portion 8E, a switching portion 9E, and an outside air temperature detector 101.

### <Bypass Passage Portion>

The bypass passage portion 8E is a passage portion connecting a portion between the pump 2 and the heat retention tank 20A and a portion between the heat retention tank 20A and the connecting portion 30A in the passage portion 8 to each other such that the washer fluid W can flow between these portions. That is, the bypass passage portion 8E bypasses the heat retention tank 20A.

### <Switching Portion>

The switching portion 9E is provided in a portion where the bypass passage portion 8E is connected to the portion between the pump 2 and the heat retention tank 20A in the passage portion 8, and switches a flow direction of the washer fluid W based on control by the controller 7. The switching portion 9E includes a solenoid valve or the like and is configured to be switchable to the following states:
A state where the washer fluid W from the pump 2 is allowed to flow to the heat retention tank 20A but is prohibited from flowing to the bypass passage portion 8E (first state)
A state where the washer fluid W from the pump 2 is allowed to flow to the heat retention tank 20A and also to the bypass passage portion 8E (second state)
A state where the washer fluid W from the pump 2 is prohibited from flowing to the heat retention tank 20A but is allowed to flow to the bypass passage portion 8E (third state).

### <Outside Air Temperature Detector>

The outside air temperature detector 101 is a temperature sensor which detects the temperature around the vehicle C (see FIG. 1), that is the outside air temperature. The outside air temperature detector 101 outputs a detection result to the controller 7.

### <Control of Switching Portion Based on Outside Air Temperature>

When the detection result of the outside air temperature detector 101 is equal to or higher than a predetermined temperature (for example, 30 degrees) set in advance, the controller 7 sets the switching portion 9E to the third state.

### <Control of Switching Portion Based on Fluid Amount in Heat Retention Tank>

Meanwhile, when the detection result of the outside air temperature detector 101 is lower than the predetermined temperature and the detection result of the fluid amount detector 26A indicates that the fluid level of the washer fluid W is below the opening 23a of the discharge-side passage portion 23, the controller 7 sets the switching portion 9E to the second state in the initial stage of the supplying of the washer fluid W. Then, after predetermined time elapses from the point where the switching portion 9E is set to the second state, the controller 7 sets the switching portion 9E to the first state.

The controller 7 may be configured to set the output of the pump 2 in a period in which the switching portion 9E is set to the second state larger than the output of the pump 2 in a period in which the switching portion 9E is set to the first state.

Moreover, when the detection result of the outside air temperature detector 101 is lower than the predetermined temperature and the detection result of the fluid amount detector 26A indicates that the fluid level of the washer fluid W is at or above the opening 23a of the discharge-side passage portion 23, the controller 7 sets the switching portion 9E to the first state during the supplying of the washer fluid W.

The controller 7 can set the time in which the switching portion 9E is set to the second state such that the lower the fluid level of the washer fluid W relative to the opening 23a of the discharge-side passage portion 23 is, the longer the time is.

### <Heating Control Depending on Alcohol Concentration>

The controller 7 sets the threshold such that the lower the outside air temperature detected by the outside air temperature detector 101 is, the higher the threshold is (see FIG. 13).

In the washer fluid supply system 1E according to the fifth embodiment of the present invention, since the washer fluid W temporarily flows through both of the heat retention tank 20A and the bypass passage portion 8E, the supply delay of the washer fluid W to the window panel C1 can be prevented by using the bypass passage portion 8E in a situation where the supply delay of the washer fluid W may otherwise occur. That is, the washer fluid supply system 1E can quickly supply the washer fluid W to the window panel C1 also in the configuration including the heat retention tank 20A.

Moreover, using the detection result of the fluid amount detector 26A allows the washer fluid supply system 1E to prevent the supply delay of the washer fluid W by using the bypass passage portion 8E in the situation where the supply delay of the washer fluid W may otherwise occur, and allows the washer fluid supply system 1E to preferably exhibit the cleaning performance by supplying the heated washer fluid W in the situation where no supply delay of the washer fluid W occurs.

Furthermore, when the outside air temperature is high, the washer fluid supply system 1E can prevent the supply delay of the washer fluid W by using the bypass passage portion 8E and preferably exhibit the cleaning performance by supplying the washer fluid W whose temperature is relatively high.

Moreover, since the washer fluid supply system 1E changes the threshold depending on the outside air temperature, when the outside air temperature is low, the washer fluid supply system 1E can set the threshold to a high value to maintain high alcohol concentration and thereby preferably prevent freezing of the washer fluid W. Furthermore, when the outside air temperature is high, the washer fluid supply system 1E can set the threshold to a low value to continue the heating by the heater 25 also when the alcohol concentration is relatively low and thereby cause the washer fluid W to preferably exhibit the cleaning performance.

### Sixth Embodiment

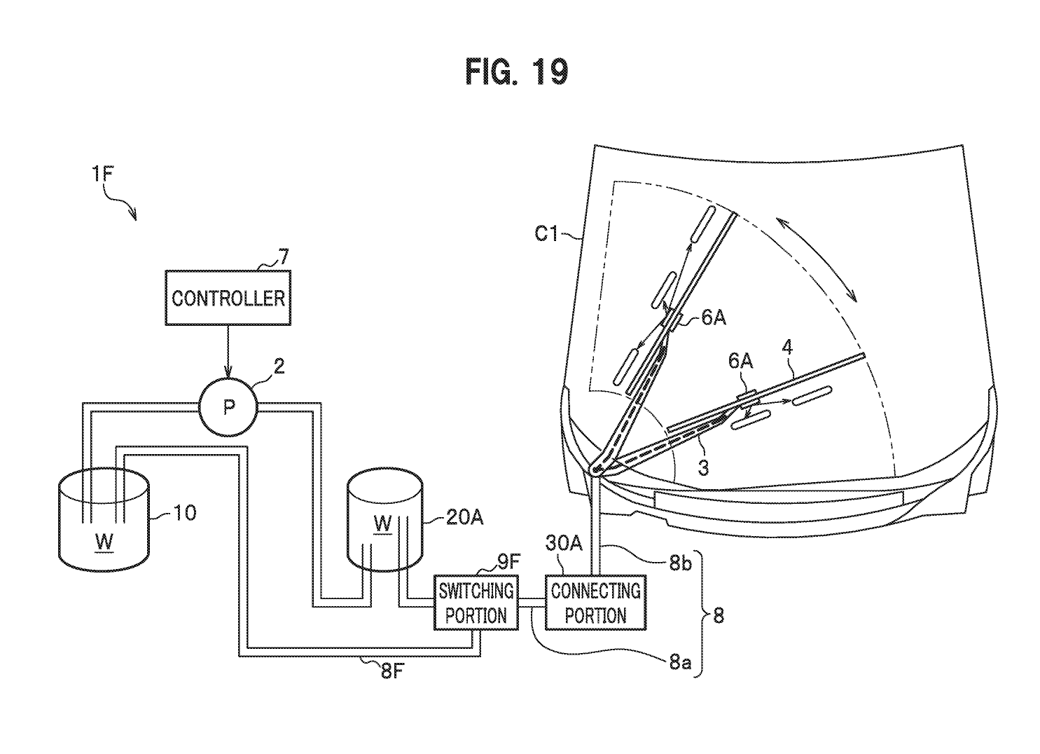

Next, a washer fluid supply system according to a sixth embodiment of the present invention is described while focusing on differences from the washer fluid supply system 1A according to the first embodiment. As shown in FIG. 19, the washer fluid supply system 1F according to the sixth embodiment of the present invention includes a return passage portion 8F and a switching portion 9F.

### <Return Passage Portion>

The return passage portion 8F is a passage portion connecting the washer tank 10 and a portion between the heat retention tank 20A and the supply portion 6A (connecting portion 30A in the embodiment) in the passage portion 8 such that the washer fluid W can flow between the washer tank 10 and the portion. That is, the return passage portion 8F returns the washer fluid W discharged from the heat retention tank 20A to the washer tank 10.

### <Switching Portion>

The switching portion 9F is provided in a portion where the return passage portion 8F is connected to the portion between the heat retention tank 20A and the supply portion 6A (connecting portion 30A in the embodiment) in the passage portion 8, and switches the flow direction of the washer fluid W based on the control by the controller 7. The switching portion 9F includes a solenoid valve or the like and is configured to be switchable to the following states:
A state where the washer fluid W from the heat retention tank 20A is allowed to flow to the supply portion 6A but is prohibited from flowing to the return passage portion 8F (first state)
A state where the washer fluid W from the heat retention tank 20A is prohibited from flowing to the supply portion 6A but is allowed to flow to the return passage portion 8F (second state).

### <Control of Switching Portion Based on Alcohol Concentration>

When the alcohol concentration detected by the alcohol concentration detector 27 is equal to or lower than the threshold, the controller 7 drives the pump 2 and sets the switching portion 9F to the second state. In this state, the pump 2 returns the washer fluid W in the tank main body 21 of the heat retention tank 20A whose alcohol concentration has dropped, to the washer tank 10 via the switching portion 9F and the return passage portion 8F. Moreover, the pump 2 delivers the washer fluid W in the washer tank 10 whose alcohol concentration is relatively high, into the tank main body 21 of the heat retention tank 20A.

Since the washer fluid supply system 1F according to the sixth embodiment of the present invention replaces the washer fluid W in the heat retention tank 20A when the alcohol concentration drops, it is possible to prevent the washer fluid W whose alcohol concentration has dropped from being delivered to the supply portion 6A.

Although the embodiments of the present invention have been described above, the present invention is not limited to the embodiments and can be appropriately changed within a scope not departing from the spirit of the present invention. For example, the target to which the washer fluid W is supplied is not limited to the window panel C1 and may be a head lamp cover of the vehicle C or the like. Moreover, the washer fluid supply systems 1A to 1F in the respective embodiments can be combined as appropriate.

Furthermore, the method of causing air bubbles to be contained in the washer fluid W in the connecting portion 30A is not limited to the method described above.

Moreover, the method of causing air bubbles to be contained in the washer fluid W in the air bubble portion 60 is not limited to the method described above. For example, the washer fluid supply system may include a compressor mounted on the vehicle C and be configured such that the air bubble portion 60 causes air bubbles to be contained in the washer fluid W by mixing air compressed by the compressor with the washer fluid W.

Furthermore, the shapes of the connection planes Y1, Y4 are not limited to linear shapes in a side view.

Moreover, the configuration may be such that the check valve is incorporated in the nozzle-side member and the air bubble portion is incorporated in the piping-side member.

Furthermore, the washer fluid supply system 1D may be configured to include a tilt detector which detects tilting of the vehicle C. In this case, the controller 7 can determine whether the fluid level of the washer fluid W is at or above the opening 23a of the discharge-side passage portion 23 by using also a detection result of the tilt detector. Moreover, the initial stage discharge amount increasing control can be applied not only to the heat retention tanks 20A, 20D but also to a heat retention tank having a structure in which discharge delay may occur, such as a structure in which the inside of the tank main body 21 has a multi-chamber structure and a structure in which a reservoir chamber is provided between the inflow-side passage portion 22 and the discharge-side passage portion 23.

Moreover, the heat retention tanks 20A, 20D may be configured to include no control circuit board 29. In this case, other units provided in the vehicle C such as the controller 7 can control the heater 25.

What is claimed is:

1. A washer tank comprising: a first tilted portion formed on an inner surface of a side wall portion of the washer tank, the first tilted portion is tilted upward toward an inner side of the washer tank, wherein the washer tank is mounted on a vehicle and stores a washer fluid.

2. The washer tank according to claim 1, wherein the washer tank further comprises a second tilted portion formed on the inner surface of the side wall portion, the second tilted portion is continuously provided to the first tilted portion and is tilted downward toward the inner side of the washer tank.

3. The washer tank according to claim 1, wherein a plurality of the first tilted portions are provided in vertical direction.

4. The washer tank according to claim 1, wherein a helical groove portion including the first tilted portion is formed on the inner surface of the side wall portion.

5. The washer tank according to claim 4, wherein a vertex of a recess portion of the groove portion is provided at a portion opposite to a vertex of a protruding portion of the groove portion in the side wall portion.
